(19) United States
(12) Patent Application Publication
(10) Pub. No.: US 2014/0214820 A1
(43) Pub. Date: Jul. 31, 2014

(54) METHOD AND SYSTEM OF CREATING A SEACH QUERY

(71) Applicant: Eugene M. ODonnell, Fishers, IN (US)

(72) Inventor: Eugene M. ODonnell, Fishers, IN (US)

(73) Assignee: CHACHA SEARCH, INC., Carmel, IN (US)

(21) Appl. No.: 14/170,031

(22) Filed: Jan. 31, 2014

Related U.S. Application Data
(60) Provisional application No. 61/759,105, filed on Jan. 31, 2013.

(51) Int. Cl. G06F 17/30

(52) U.S. Cl. CPC G06F 17/30525
USPC 707/726

(57) ABSTRACT

A system and method for disambiguation of a query is provided. The system and method identifies elements of a query which may be ambiguous and assists a person to resolve any ambiguous elements. Algorithmic processing may provide auxiliary information which may be selectively presented with a query and/or a response to a query.

### BACKGROUND

1. Field of the Invention

The present invention is related to creation of a search query.

2. Description of the Related Art

In a system which responds to user requests for information, one of the most difficult problems is that of understanding the user's intent. In the case of conventional information retrieval, this problem is solved by forcing the user to create a query which returns the information desired based on examination of the search results by the user. An example of this type of system is the Google or Bing® search system wherein a user inputs a few keywords which are then used to find websites based on a scoring or ranking system associated with those websites.

Such systems are not effective at answering more specific queries such as “how deep is the Marianas Trench?”, or “How many goldfish fill a one quart container?” Because it is desirable to find information at that sort of level of granularity, systems such as the ChaCha® and Ask Jeeves® answering services were created to provide this type of service. However, this type of service may still struggle to answer a user's question well. It is quite easy for a user to type a query which includes typographic errors or which includes implied information which is obvious to the user, but which cannot be used by a machine or a person to respond with the desired information.

This problem is further aggravated by the combinatorial explosion of human language. Many questions are in fact alternate forms of the same request for information. For example, “How tall was George Washington?” is identical to “What was George Washington's height?” but there is no simple means whereby the semantic connection may be made. Consequently a question answering system will be forced to find an answer to both queries despite the equivalence relationship.

Because of these and other problems a method and system of creating a predicted query would be greatly appreciated

### SUMMARY

A system is provided which includes a query processing server which receives queries, determines an appropriate response, and distributes the query, a guide system operated by a human searcher receiving a request and providing a search result, and a user system submitting a request.

When a query is received by the search system, the query may be analyzed to determine if an automated response to the query is suitable. When a query matches a stored or programmatically generated query, a stored response and information associated with the stored response may be obtained. In order that a user query can be better matched to a stored query, the user query may be analyzed to determine a most probable query associated with the user input. As a user inputs a query, a most likely query is provided to the user as a query which will be submitted for a search.

A user query is resolved to an unambiguous query. If a user query is not unambiguous, a query is presented which is unambiguous. Disambiguation of a query may include resolving use of pronouns by substitution of nouns or proper nouns in place of pronouns. Disambiguation may include appending location information to a query which is determined to be location sensitive. Disambiguation may include addition of temporal information to a query. Disambiguation may include mapping a user query to an alternate phrase for the query which is determined to be an equivalent to a user query. Disambiguation may include correction and/or suggestion of alternate spelling of words or phrases of a user query based on a dictionary matching. Disambiguation may include suggested grammar corrections and/or word substitutions. Disambiguation may include warnings regarding questionable elements of a query. Disambiguation may include removal of contractions and other deletions or additions which may reflect an indexed query and/or partial query. Alternate forms of words or phrases which are associated with human searchers and/or other items which may be used to assist a search and/or provide a search result may be substituted.

If a user query is disambiguated, augmented, corrected, or modified, a user may be provided with an opportunity to review actions associated with disambiguating a query. For example, corrections to spelling or grammar, modifications to phraseology, addition of geographic, temporal, profile and/or other implied information of a request may be identified to a user, who may be able to identify and modify elements of an explicit query as desired. A user may be presented with alternative disambiguation elements based a ranking of corrections which may be applied. A user may be required to correct and/or accept an explicit or disambiguated query prior to submitting a query for a search. A user may be provided with an ability to select any or all elements of an explicit query which may be modified to cause the explicit query to match a stored and/or programmatically determined query.

Additional aspects and/or advantages will be set forth in part in the description which follows and, in part, will be apparent from the description or may be learned by practice of the invention. These together with other aspects and advantages, which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for guides.

FIG. 5 illustrates a database for resources.

FIG. 6 illustrates a database for a reference query.

FIG. 7 is a flowchart of predicting a query.

FIG. 8 is a flowchart of processing a query.

FIG. 9 is a Graphical User Interface (GUI) for entering a query.

FIG. 10 depicts a GUI for modifying an explicit query.

FIG. 11 depicts a GUI for modifying an explicit query.

FIG. 12 depicts a GUI for modifying an explicit query.

FIG. 13 is a GUI for receiving an answer.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search server receiving the query and providing a response, a database storing information of queries, search results, searchers, users, resources, a lexicon, a gazette, a dictionary, a thesaurus, query templates, advertisements and other information, and a guide system receiving a query and providing a search result.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A first layer may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources.

A third layer of processing of a query may include a human assistant who responds to the query or “searcher”. A searcher may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services.

As used herein, a “request” means a request for information, products, and/or services. A request or search request or query may include various types of media, and may be provided by any user system which may establish communication with a server and/or other devices associated with a search service. A request may be referred to as a “search request”, “search query”, “question” or “query”.

A “user” is a person who submits a request and may receive any type of information responsive to a request. A user may be any person or entity. A “guide” is a person who assists in processing a request. A guide may be referred to as a “provider”, “searcher”, “human searcher”, “vetter”, “expediter”, “transcriber”, “specialist” or “generalist”. Guides may be assigned various roles. A guide who transcribes a user request from one form to another may be referred to as a transcriber. A guide who reviews a query, determines a most likely response, and may modify a query may be referred to as an expediter, “vetter” or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, “reply” or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc.

A device such as a user device may be provided with an interface which is used to indicate modifications to a query which are implemented in order to create an unambiguous or explicit query. A current most probable or currently determined explicit query may be referred to as a Predicted Explicit Query or PEQ. A PEQ may be used to assist a user in more rapidly and/or precisely entering a search query or request. For example, a user may be familiar with a conventional search engine which answers the question “What is the highest ranked search result for the keyword(s) I typed?” This is the approach of a conventional search engine such as Google or the Bing® search engine by Microsoft. These types of search engines may perform poorly when attempting to locate an answer to a specific question, but a user may be more accustomed to this style of query entry. Further, the specific information sought by a user may be more easily predicted based on a match of keywords to a list of words and/or phrases. For example, a one-word query such as “dog” is entirely ambiguous as a natural language query. However, if a most commonly posed question associated with a single word (xxx) is “define xxx”, a PEQ of “What is the definition of dog?” would naturally fit the user's desire, while requiring the entry of only one word, rather than six. Other PEQ's associated both with a single word and/or the keyword “dog” might be ranked in order of probability, and as additional input is received, a more probable PEQ may be provided.

A PEQ may be determined based on a database associated with a number of keywords. For example, if a keyword is linked with various facts and/or attributes, a PEQ which would provide information linked to the keyword may be more probable to be presented than a PEQ which is not associated with the keyword and facts and/or attributes. A PEQ may be determined based on a match to a keyword when a particular attribute or fact may be associated with the keyword but is not currently associated with the keyword. For example, if a person may be associated with an attribute such as date of birth, or home town, but that fact or information is not currently associated with the person, a PEQ which would obtain the unknown information may be presented to a person such as user or information seeker and/or a human assistant.

A PEQ may utilize inferred data regarding a source of a query. For example, if a query such as “weather” is entered, location information associated with a user device such as an IP address, phone number, cell phone triangulation, WiFi location, or GPS data may be used to disambiguate the query to “What is the current weather in Indianapolis, Ind.?” if geographic information is inferred. If geographic information cannot be inferred, or is erroneous, a user may be prompted to provide and/or confirm geographic information. A user query may exactly match a previous query, but an answer associated with the query may be ‘stale’. Detection of temporally sensitive queries is quite difficult as context may not provide sufficient information. For example, the query “Is John Jones alive?” is a matter of fact, but might change at any time. Unless a query is determined not to be temporally sensitive, a time-stamp associated with a stored answer may be appended to a query associated with a user query, to produce a PEQ which includes the time stamp, such as “Was John Jones alive on June ninth of last year?” based on the time stamp. A user may be able to override the time stamp date to for example “currently” in order to receive an answer which is confirmed as of the current time and date, or may accept the previous answer.

Grammar, spelling, corrections, substitutions, reformulation, etc. which are applied to user query to create a PEQ may be identified in a PEQ provided to a user. For example, as a user inputs a query as text, well known techniques such as predictive text may suggest corrections to user text based on heuristic rules and/or statistical predictions. Likewise, if a PEQ based on user input would match a stored query if a word substitution were performed, that PEQ may be provided responsive to a user input with the substituted word indicated. A morphism or modification applied to user input which is used to generate a PEQ may be indicated in order that an explicit query is formed. In at least one embodiment, a PEQ creation interface may be made available to a guide. A PEQ determined by a guide may be presented to a user responsive to a user query. If an element of a query such as a noun, verb or phrase is determined not to have a specific meaning, a most probable or likely meaning of the element may be indicated in a PEQ and alternatives may be made accessible.

A query may be classified in order that the query is managed more effectively. For example, a query which is subjective might be routed differently than an objective question of fact. The former might be readily answered by someone with limited knowledge of the subject of the query, while the latter might require expertise and/or research in order to obtain the information. If a query is determined to be subjective and/or objective, an indication might be provided with a PEQ which would indicate how the query is to be directed. In a similar manner, a query may be determined to be location sensitive based on content analysis. If an ambiguous element is resolved by an inferred location, the inferred location which is used to disambiguate the query may be provided to allow the PEQ to be vetted and/or revised.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

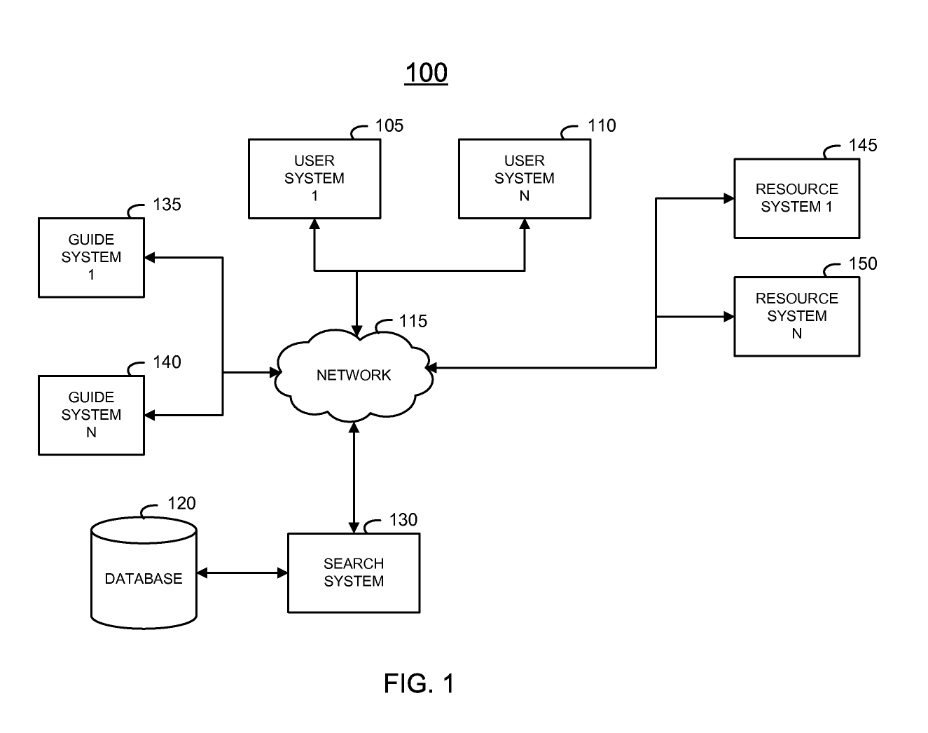

As illustrated in FIG. 1, system 100 includes user systems 105, 110, a network 115 such as the Internet, a search system 130, a database 120, which may comprise various records, guide systems 135, 140 and resource systems 145, 150.

While only a few systems associated with a user and a guide are depicted in FIG. 1 it is within the scope of the disclosure for multiple systems for a user and a guide to be utilized. In particular it is envisioned that many user and guide systems may be implemented. The search system 130 may be a composed of many components as described further herein.

Any user system (e.g. the user system 105) can be used, to submit a request to the search system 130 and/or receive a result and/or other information. Any user system may receive a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, and the resource systems 145, 150 with the other components of the system 100 such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140, and the resource systems 145, 150. For example, a request can be transmitted from the user system 105 to the search system 130, which may provide information obtained from the database 120, which may include an advertisement to the user system 105. Similarly, a search result from a searcher operating the guide system 135 might be routed to the search system 130, which might process the search result, formulate a response and provide a message to the user system 105. Any type of communication between users and/or guides may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the guide systems 135, 140, and the search system 130 may include equipment, software, systems and personnel required to send and/or receive messages between a user system 105, 110, the guide systems 135, 140, and/or the search system 130 using the network 115. The database 120 includes information which may allow the search system 130 to establish communication between any or all of the elements of the system 100.

A user system, a guide system, a resource system and/or a search system may be a desktop, portable, or tablet PC or Mac® personal computer, a mobile phone, a smart phone, a PDA, a server system, a landline phone, a specialized communication terminal, a terminal connected to a mainframe, or any other communication hardware and/or system. The search system 130 and/or resource systems 145, 150 may include one or more servers, computers, etc. For example, servers such as the PowerEdge® 2900 server by Dell, or the BladeCenter®JS22 server by IBM, or equivalent systems might be used to implement elements of the search system 130. The search system 130 may utilize an operating system (OS) such as Microsoft Windows XP®, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 105 and a guide system and/or the search system 130. Information such as a keyword, a category, a user profile, a request, a result, etc., may be associated with a user. A user may be required to provide profile information to the search system 130. A user may elect to receive requests from the search system 130. Information of a user may be stored in the database 120.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system and/or the search system 130.

When a guide registers with the search system 130 the guide may be associated with one or more keywords, categories, profiles, and/or other information. Information associated with a guide may be stored in the database 120 and may be used for various purposes. Information associated with a guide may be used to select and/or rank requests, resources, results, advertisements, sponsors and/or other information accessible to the search system 130 which may be presented or provided to a guide. In at least one embodiment, payment information is associated with a guide. In at least one embodiment, a guide may be required to undergo testing to determine whether a guide is able to perform any tasks which may be required by the search system 130. For example, a guide may be assigned to a role such as translator, transcriber, expediter, generalist, specialist, auditor, etc. A guide may be registered by a sponsor. A sponsor may provide compensation to a sponsored guide.

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables and/or other data structures as is well known in the art, as further described herein. While a limited number of records are described for the purposes of illustration it is envisioned that many records might be used to implement the system 100 (FIG. 1).

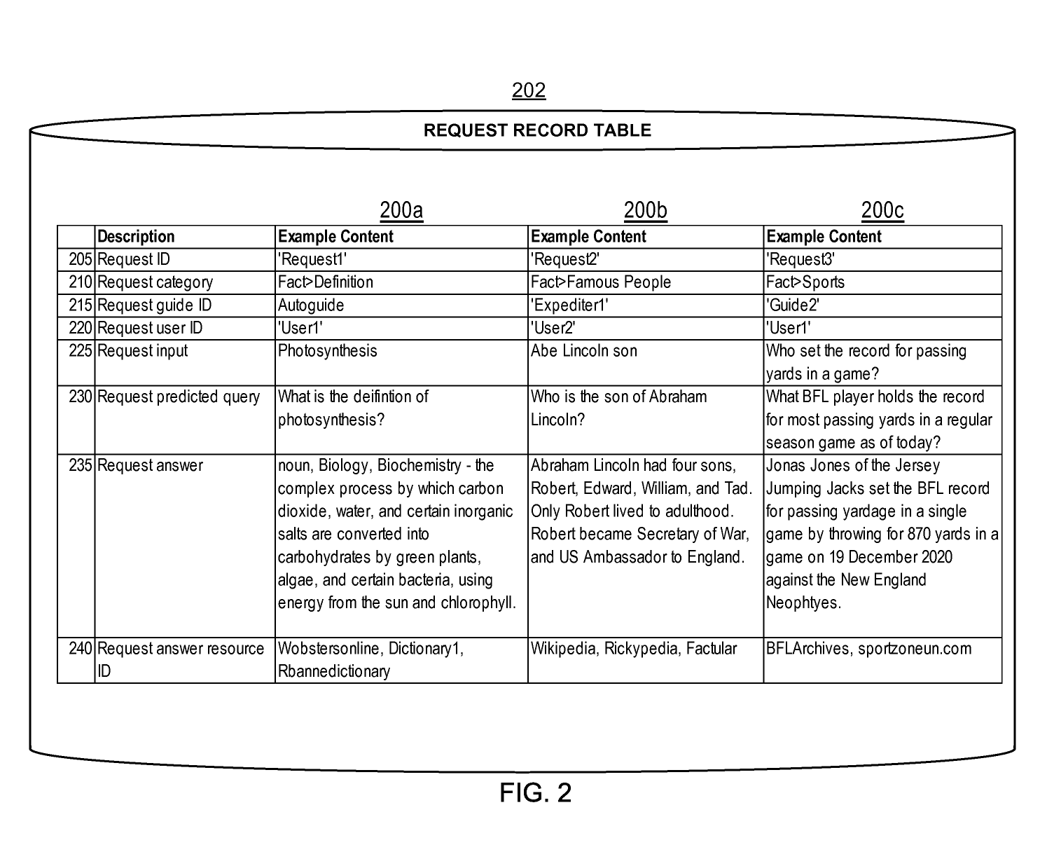

As illustrated in FIG. 2 an exemplary request record table 202 which may comprise a number of request records 200a-200c of which one or more may be associated with or resident in the database 120 (FIG. 1) is provided. The request record table 202 may include information of requests which may be processed. The request records 200a-200c may include a request ID field 205, a request category field 210, a request guide ID field 215, a request user ID field 220, a request input field 225, a request predicted query field 230, a request answer field 235, and a request answer resource ID field 240.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to rank guides who may be associated with a type or category of a request. Likewise, a category associated with a request may be used to rank requests which may be presented to a guide. A category associated with a request may be determined based on factors such as keywords of a query, a profile of a user, a selection of a guide, a user history, etc. A category associated with a system taxonomy may be indicated in the request category field 210. A category may be associated with a request automatically and/or using the assistance of a person. Using the example in Fig. example in FIG. 2, ‘Request2’ may be categorized as ‘Fact>Famous People’ as indicated in the request record 200b. This may indicate that a person or item associated with the category ‘Fact>Famous People’ may have a higher ranking for responding to ‘Request2’, which may affect a probability that a query is directed to a person. A category of a request may be associated with a user submitting the request. Content of a request such as a keyword, named entity, etc. may be used to assign a category or type to a request. A match of a request to a PEQ may determine a category associated with a request.

The request guide ID field 215 may include information of a number of guides associated with a request. Content of the request guide ID field 215 may be used to obtain information of a guide. If a person is selected for a request, elects to receive a request, provides a response to a request, reviews a result of a request and/or completes a request, an identifier of the person may be indicated in the request guide ID field 215. Using the example in FIG. 2, ‘Expediter1’ is associated with ‘Request2’. This may for example indicate that ‘Request2’ has been processed by ‘Expediter1’. Any user may be a guide or responder or human assistant or searcher.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. A request may not be associated with a user request. For example, the search system 130 (FIG. 1) may provide requests to persons which are not directly related to a user request. The search system 130 may provide a request to a searcher based on a selection of the request based on queries submitted by a plurality of users. The search system 130 may create a request based on a data structure associated with a subject of a query which is not completed. For example, if a query is received regarding a famous person and information which is frequently requested regarding other famous people is not available a request to obtain the information may be created by the search system 130 and provided to a guide. Using the example in FIG. 2, ‘User1’ is associated with ‘Request1’ and ‘User2’ is associated with ‘Request2’. This may indicate that ‘Request1’ was submitted by ‘User1’ while ‘Request2’ was submitted by ‘User2’.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘Who set the record for passing yards in a game?’ is the request input associated with ‘Request3’, as indicated in the request record 200c. In at least one embodiment, the request input field 225 may indicate an original user request.

The request predicted query field 230 may include information of a predicted query associated with a request. Content of the request predicted query field 230 may be provided to a user and/or a guide responsive to a request. Content of the request predicted query field 230 may be stored in the database 120 (FIG. 1). Content of the request predicted query field 230 may be reviewed and/or rated by a user, a guide, and/or an administrator. As illustrated in FIG. 2, the predicted query “What BFL player holds the record for most passing yards in a regular season game as of today?’” is associated with ‘Request3’ as illustrated in the request record 200c. As is readily apparent the predicted query includes more specific information which has been applied the request input. In an embodiment, the predicted query is presented to a user submitting the original query. A predicted query may be provided to a guide.

The request answer field 235 may include information of an answer associated with a request. Content of the request answer field 235 may be used to provide a search result. For example, a guide may cut a snippet of text from a web page in order to create a response to a request. An answer may include various types of media such as text, images, audio, html, etc. Content of the request answer field 235 may be produced automatically and/or using the assistance of a person. Using the example in FIG. 2, the answer ‘Jonas Jones of the Jersey Jumping Jacks set the BFL record for passing yardage in a single game by throwing for 870 yards in a game on 19 Dec. 2020 against the New England Neophytes.’ is associated with the request record 200c, which may indicate that ‘Request3’ was answered using a that response.

The request answer resource field 240 may include information of a resource associated with a request. Content of the request answer resource field 240 may be used for various purposes. A URL associated with a response may be used to determine whether a response is reliable. As illustrated in FIG. 2, a URL associated with a commercial search engine is associated with ‘Request1’ which may indicate that a stored response associated with ‘Request1’ must be treated according to a pre-determined set of rules. For example, reliability or credibility of a resource may determine whether an answer is presented, whether a predicted query associated with a result is presented, etc. In at least one embodiment, a ranking of a resource may affect a PEQ which is offered responsive to a request. For example, a PEQ associated with a credible source may be more likely to be presented than a PEQ associated with a less credible or lower ranked source or resource.

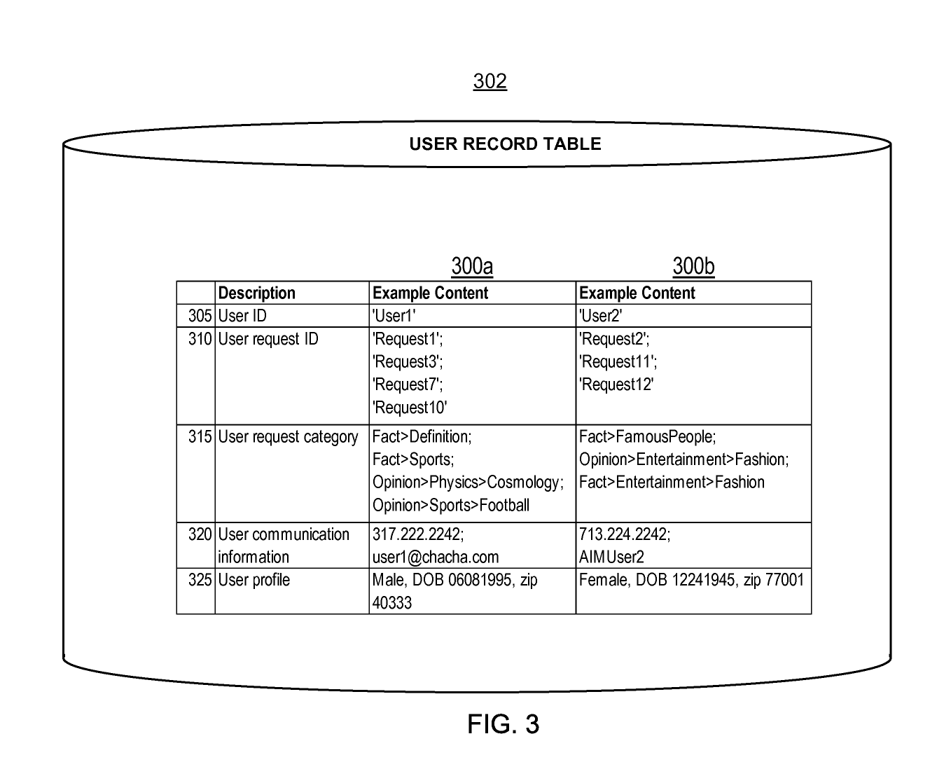

As illustrated in FIG. 3 an exemplary user record table 302, which may comprise a number of user records 300a-300b of which one or more may be associated with or resident in the database 120 (FIG. 1) is provided. The user record table 302 may include information of users. The user records 300a-300b may include a user ID field 305, a user request ID field 310, a user request category field 315, a user communication information field 320, and a user profile field 325.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request2’, ‘Request11’ and ‘Request12’ are associated with ‘User2’ as indicated in the user record 300b. This may indicate that ‘User2’ has submitted ‘Request2’, ‘Request11’ and ‘Request12’.

The user request category field 315 may include information regarding a category or type associated with a user request. For example, if a request is directed to a type of processing or a category, etc. a type and/or category associated with the processing may be indicated in the user request category field 315. In at least one embodiment, the user request ID field 310 and the user request category field 315 are linked by for example a pointer. In at least one embodiment, a category associated with a request of a user may affect a method whereby an answer will be provided. For example, a request for factual information may be directed differently than a request which is classified as subjective or opinion.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with ‘User1’.

The user profile field 325 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, answer history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. A sponsored answer might be modified based on geographic, demographic, etc. profile information of a user.

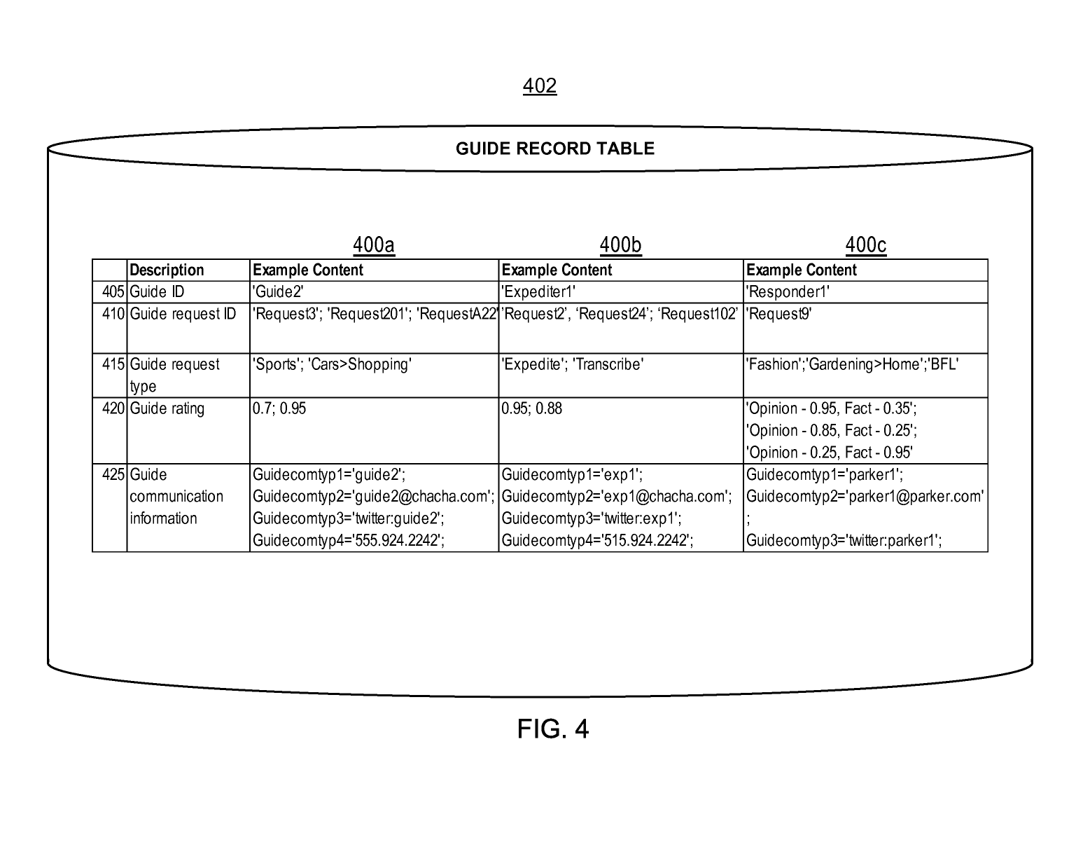

As illustrated in FIG. 4 an exemplary guide record table 402 is provided. The guide record table 402 may comprise a number of guide records 400a-400c of which one or more may be associated with or resident in the database 120 (FIG. 1). The guide record table 402 (FIG. 4) may include information of guides. The guide records 400a-400c may include a guide ID field 405, a guide request ID field 410, a guide request type field 415, a guide rating field 420, and a guide communication information field 425.

The guide ID field 405 includes an identifier of a guide which is preferably unique and is preferably used consistently. A guide ID serves to distinguish a guide record associated with a guide from a guide record associated with other guides. Any number of characters, numbers, and/or other indicators may be used to indicate a guide ID. In at least one embodiment, a random number is indicated in the guide ID field 405. In at least one embodiment, a pseudonym selected by a guide may be indicated in the guide ID field 405. Using the example in FIG. 4, ‘Guide2’ is the guide ID associated with the guide record 400a.

The guide request ID field 410 may include information of a number of requests associated with a guide. Content of the guide request ID field 410 may be used to obtain information of a request. For example, if a user request has been determined to require a number of requests to be performed, the search system 130 (FIG. 1) may assign a unique ID to the requests and may distribute information of the requests to guides. Using the example in FIG. 4, ‘Request2’, ‘Request24’ and ‘Request102’ are associated with ‘Expediter1’ as indicated in the guide record 400b. This may indicate that ‘Expedited1’ has expedited or handled ‘Request2’, ‘Request24’ and ‘Request102’.

The guide request type field 415 may include information of a number of types of requests which may be processed by a guide. For example, a category and/or keyword associated with a request, a type of request, temporal information associated with a request, etc., which may be used to determine if a guide is to be presented with a request may be indicated in the guide request type field 415. In at least one embodiment, a guide may be assigned to a particular type of request as part of a registration process. A guide may select a type of request which the guide may perform. A guide may be required to pass a test in order to be associated with a type of request. A guide may be assigned to a role such as expediter, searcher, etc., which may be indicated in the guide request type field 415. A request indicating a keyword may be directed to a guide. A guide may be associated with responding to factual and/or subjective requests.

The guide rating field 420 may include information of a number of ratings associated with a guide. For example, quality, speed, peer review, etc., may be used to determine a rating of a guide. A rating of a guide may be used for purposes such as determining compensation for the guide, selecting a guide to respond to a request, matching a request to a guide, etc. In at least one embodiment, the guide request type field 415 and the guide rating field 420 may be linked by, for example, a pointer. Using the example in FIG. 4, ‘Expediter1’ has a rating of ‘0.95’ associated with ‘Expedite’, and a rating of ‘0.88’ associated with ‘Transcribe’ which may be used to rank ‘Expediter1’ versus other guides associated with the request types ‘Expedite’ and ‘Transcribe’. Similarly, ‘Responder1’ is associated with ratings for ‘Fashion’, ‘Gardening>Home’, and ‘BFL’ which are further associated with the request types Opinion and Fact. This may indicate that if a query relating to ‘Fashion’ is factual in nature ‘Responder1’ might be less likely to be selected to respond than if the query is subjective. While a few examples of linking a guide to a rating for a type of request have been used for purposes of illustration, any suitable data structures and systems which are well known in the art may be used within the scope of the embodiments described herein.

The guide communication information field 425 may include information of a number of communication services associated with a guide. For example, a user name and password, an email address, an IM credential, a phone number, a web page, a physical address, etc., may be indicated in the guide communication information field 425. Using the example illustrated in FIG. 4, ‘Guide2’ is associated with the login ID ‘guide2’, the email ‘guide2@chacha.com’, the Twitter account ‘twitter.guide2’, and the phone number ‘555.924.2242’. This may indicated that ‘Guide2’ may be contacted using the associated communication services.

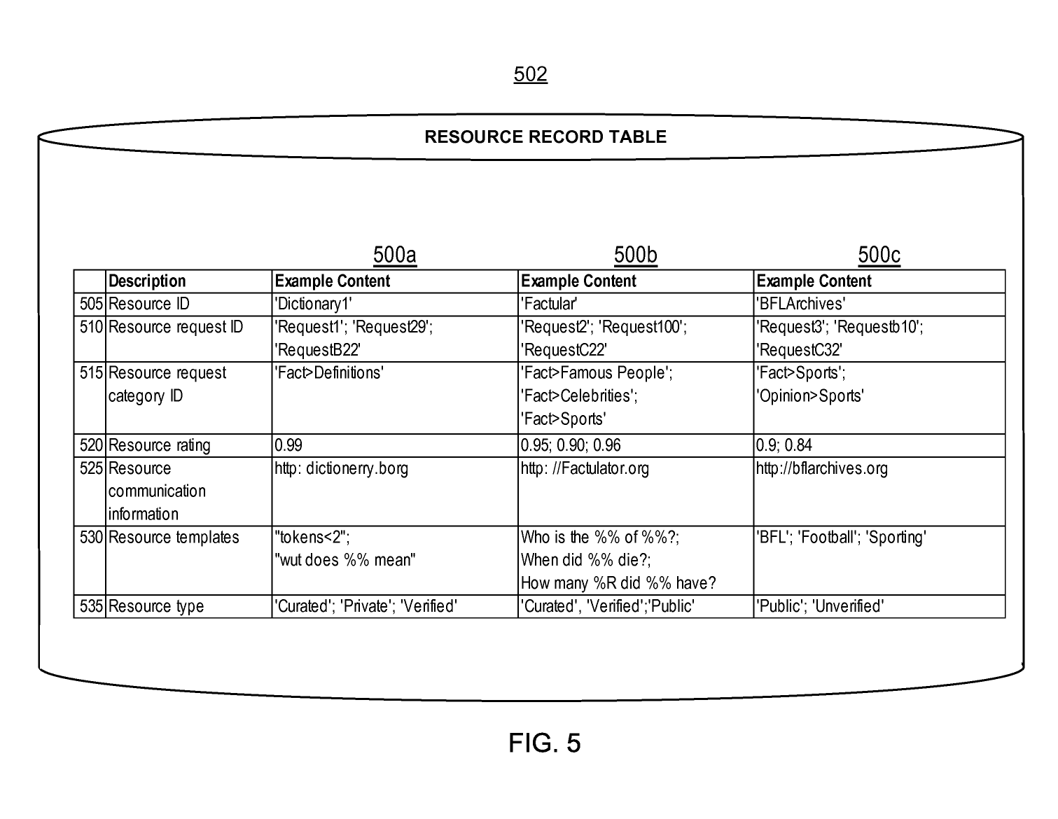

As illustrated in FIG. 5 an exemplary resource record table 502 is provided. The resource record table 502 may comprise a number of resource records 500a-500c of which one or more may be associated with or resident in the database 120 (FIG. 1) is provided. The resource record table 502 (FIG. 5) may include information of resources. The resource records 500a-500c may include a resource ID field 505, a resource request ID field 510, a resource request category ID field 515, a resource rating field 520, a resource communication information field 525, a resource templates field 530, and a resource type field 535.

The resource ID field 505 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 5, ‘Dictionary1’ is the resource ID associated with the resource record 500a. This may indicate that ‘Dictionary1’ has been used to produce a search result, and is accessible to a guide.

The resource request ID field 510 may include information of a number of requests associated with a resource. Content of the resource request ID field 510 may be used to obtain information of a request. For example, if a resource has been used to respond to a request, an identifier of the request may be indicated in the resource request ID field 510. Using the example in FIG. 5, ‘Request2’, ‘Request100’ and ‘RequestC22’ are associated with the resource ‘Factular’ as indicated in the resource record 500b. This may indicate that ‘Factular’ has been utilized to respond to ‘Request2’, ‘Request100’ and ‘RequestC22’.

The resource request category ID field 515 may include information of a number of categories of requests which may be processed by a resource. For example, a category and/or keyword associated with a request, a type of request, profile, etc., which may be used to determine if a resource is to be presented to a guide for a request may be indicated in the resource request category ID field 515. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 5, ‘BFLArchives’ is associated with the categories ‘Fact>Sports’ and Opinion>Sports' as indicated by the resource record 500c. This may indicate that a person selected to respond to a query associated with ‘Fact>Sports’ and/or Opinion>Sports' may be provided with information of ‘BFLArchives’ and/or that a result may be obtained from ‘BFLArchives’.

The resource rating field 520 may include information of a number of ratings associated with a resource. For example, a rating of a resource may be based on ratings of answers produced using the resource, a contractual agreement, an affiliation, temporal information such as time spent by guides, etc. A rating of a resource may be used to select a resource which is provided to a searcher or guide, to rank a response associated with a resource, etc. In at least one embodiment, the resource request category ID field 515 and the resource rating field 520 may be linked by, for example, a pointer. Using the example in FIG. 5, ‘Factular’ has a rating of ‘0.96’ associated with ‘Fact>Sports’, and ‘BFLArchive’ has a rating ‘0.9’, associated with ‘Fact>Sports’ which may indicate that ‘Factular’ is more likely to produce an acceptable response for that category. A resource may have a rating corresponding to various categories, types of information, types of tasks, keywords, etc. Ratings associated with categories, types, profiles, etc. may be used to rank resources and select resources for purposes such as presentation to a guide, determination of a predicted query, ranking of information used to make a query more explicit, etc.

The resource communication information field 525 may include information of a number of communication services associated with a resource. For example, a user name and password, an email address, an IM credential, a phone number, a web page, a physical address, an API key, etc., may be indicated in the resource communication information field 525. A communication service indicated in the resource communication information field 525 may for example be used to indicate a service by which a resource may be accessed. Using the example illustrated in FIG. 5, the URL <<http: dictionerry.borg>> is associated with ‘Dictionary1’. This may indicate that a query associated with ‘Fact>Definitions’ may be submitted to that URL by for example an API. Likewise a rating associated with ‘Dictionary1’ may be used to determine whether a result from Dictionary1 or a PEQ returned by Dictionary1 may be provided responsive to a request.

The resource template field 530 may include information of a number of templates, keywords, and/or filters associated with a resource. A match to a keyword indicated in the resource keyword field 530 may affect a probability that a request will receive a response associated with a resource. For example, a match may prohibit a query from receiving a result from a resource, may increase a ranking of a resource, may be used to associate a category with a request, may identify a resource to be provided to a guide, etc. In at least one embodiment, keywords included in requests for which a resource has provided an answer may be more highly ranked for a category associated with the query and the resource. Templates associated with a resource may be provided by a provider of the resource, derived from successful responses to queries, determined by a person, may be associated with processing functionality operative in a resource and/or may be determined by an Application Program Interface (API) associated with a resource. For example, the templates associated with ‘Dictionary1’ may indicate that if a query includes less than two words, or the query matches the text “wut does %% mean” and the text which is variable based on %% is found in a list associated with ‘Dictionary1’ a PEQ provided based on ‘Dictionary1’ may be ranked more highly.

The resource type field 535 may include information of a number of types or characteristics associated with a resource. A type may include an indication of an access right, a commercial arrangement, a preference, quality of content, source of content, etc. A searcher and/or user may elect to associate a resource with a type. A system administrator may associate a type with a resource. A provider of a resource may designate a type associated with the resource as part of a registration process. Using the example in FIG. 5, ‘Dictionary1’ is a ‘Verified’, ‘Private’, ‘Curated’ resource. This may indicate that content of the resource is controlled (i.e., curated) by the provider of the resource, that the resource is not accessible to the general public, and that the content of the resource is verified to be correct.

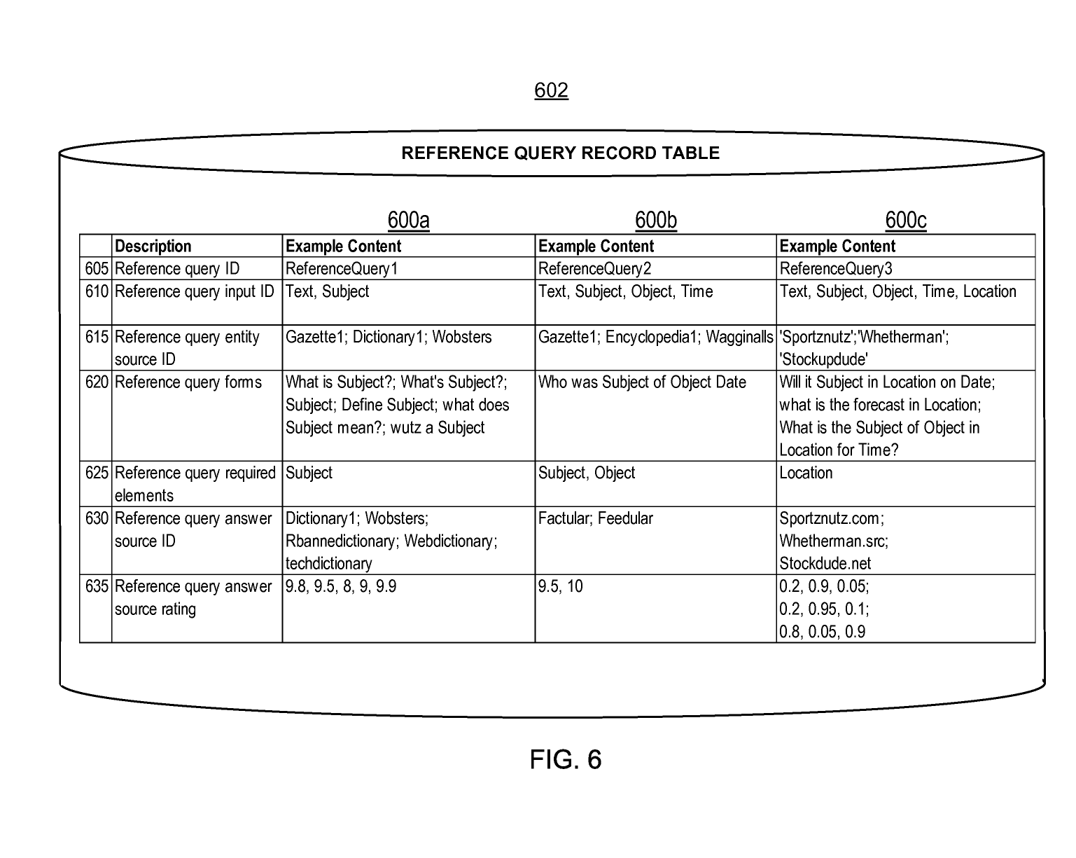

As illustrated in FIG. 6 an exemplary reference query record table 602 is provided. The reference query record table 602 may comprise a number of reference query records 600a-600c of which one or more may be associated with or resident in the database 120 (FIG. 1) is provided. The reference query record table 602 (FIG. 6) may include information of reference queries. The reference query records 600a-600c may include a reference query ID field 605, a reference query input ID field 610, a reference query entity source ID field 615, a reference query forms field 620, a reference query required elements field 625, a reference query answer source ID field 630, and a reference query answer source rating field 635.

The reference query ID field 605 includes an identifier of a reference query which is preferably unique and is preferably used consistently. A reference query ID serves to distinguish a reference query record associated with a reference query from a reference query record associated with other reference queries. Any number of characters, numbers, and/or other indicators may be used to indicate a reference query ID. Using the example in FIG. 6, ‘ReferenceQuery1’ is the reference query ID associated with the reference query record 600a.

The reference query input ID field 610 may include information of parameters associated with a reference query. Content of the reference query input ID field 610 may be used to provide a response. Content of the reference query input ID field 610 may include an indication of a type of information which may be used as input for the reference query, elements of a reference query which may be identified, and other elements of a reference query which may be used to disambiguate a user query in order that a source associated with the reference query can provide a response. For example, ‘ReferenceQuery3’ indicated in the reference query record 600c might be used to generate and or analyze user inputs which are textual and which may include the parameters “Subject’, ‘Object’, ‘Time’ and ‘Location’.

The reference query entity source ID field 615 may include information of resources which may be used to identify elements of a query in order that a query can be disambiguated. For example, a reference query entity source reflected in the query entity source ID field 615 may be used to determine information of a source of nouns, verbs, adjectives, audio clips, images, etc. which may be used to determine whether a query includes those items. A reference query entity source may be used to perform tasks such as grammar and spelling suggestions or corrections. A match between an entity provided by a reference query entity source and a query may increase a rating associated with a reference query answer source which may be associated with a query.

The reference query forms field 620 may include information of templates which may be used to establish equivalence relationships between queries. For example, Regular Expressions (Regex) may be indicated which might be used to determine a PEQ which is equivalent or highly ranked for a query. A reference query form may be coded as an annotation graph which may be used to determine whether a query is sufficiently complete that a PEQ can be determined. A match between a reference query form indicated in the reference query forms field 620 may be used to rank the reference query form for a query.

The reference query required elements field 625 may include information of elements which are required to be provided in order that an answer or response associated with a reference query can be provided. For example, if a response associated with ‘ReferenceQuery3’ is to be provided, the element ‘Location’ may be required as indicated in the reference query required elements filed 625 of the reference query record 600c. Any number of elements may be required for a reference query. If an element of a query is recognized based on stemming, morphology, context, etc. an indication associated with a basis for recognition of the element may be provided. If a required element of a reference query is not provided by a user input, a default and/or inferred value may be selected. If a required element is selected without user action, a user may be requested to affirm a value of a required element prior to processing of a query.

The reference query answer source ID field 630 may include information of a number of answer sources associated with a reference query. An answer source may not provide entity matching information which is associated with a reference query even if it is an answer source. As indicated in the query record 600b, reference query entity sources may be different from reference query answer sources associated with a reference query. For example, entity information may be extracted from a heterogeneous collection of objects, analyzed in terms of word frequency, and evaluated to determine an entity list for a topic, subject matter, category, and/or a reference query. A reference query answer source may not provide an entity list, but may be used to obtain an answer. For example, a resource associated with a human assistant may receive a query which matches a reference query but does not include an element which matches an entity list associated with a reference query or entity provided by the resource.

The reference query answer source rating field 635 may include information of a number of ratings associated with a reference query answer source. A rating associated with a reference query answer source may be used to determine whether a response can be obtained, a good result is produced, a preference due to cost or availability, etc. regarding a reference query answer source. A rating associated with a reference query answer source may be associated with a query form, with a matching to a reference query entity source, a category, etc. As illustrated in FIG. 6, the reference query answer sources associated with ‘ReferenceQuery1’ may be generally applied, while the ratings associated with the answer sources associated with ‘ReferenceQuery3’ may be associated with the reference query forms indicated in the reference query forms field 620 of the reference query record 600c.

While particular groupings, structures and linkages of information have been used for the purposes of illustration no limitation is implied. Other equivalent data constructs and structures which would readily occur to one of ordinary skill in the relevant art may be used to implement the records and tables described herein as would be required for the operation of the embodiments disclosed herein.

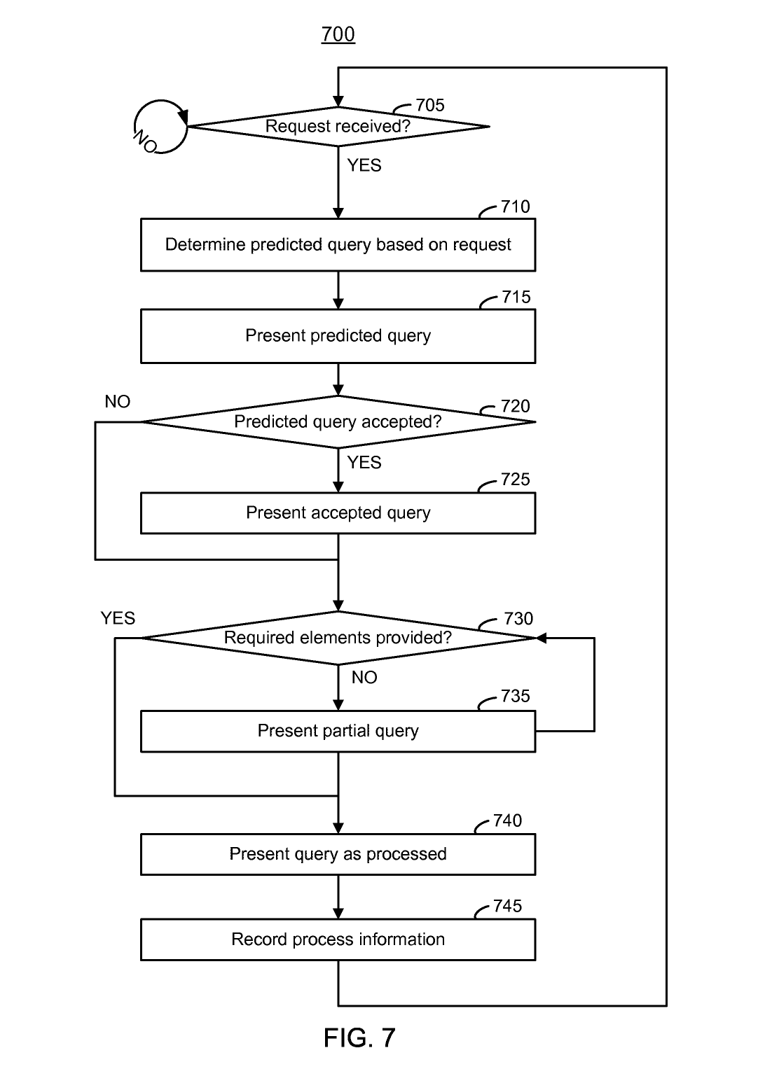

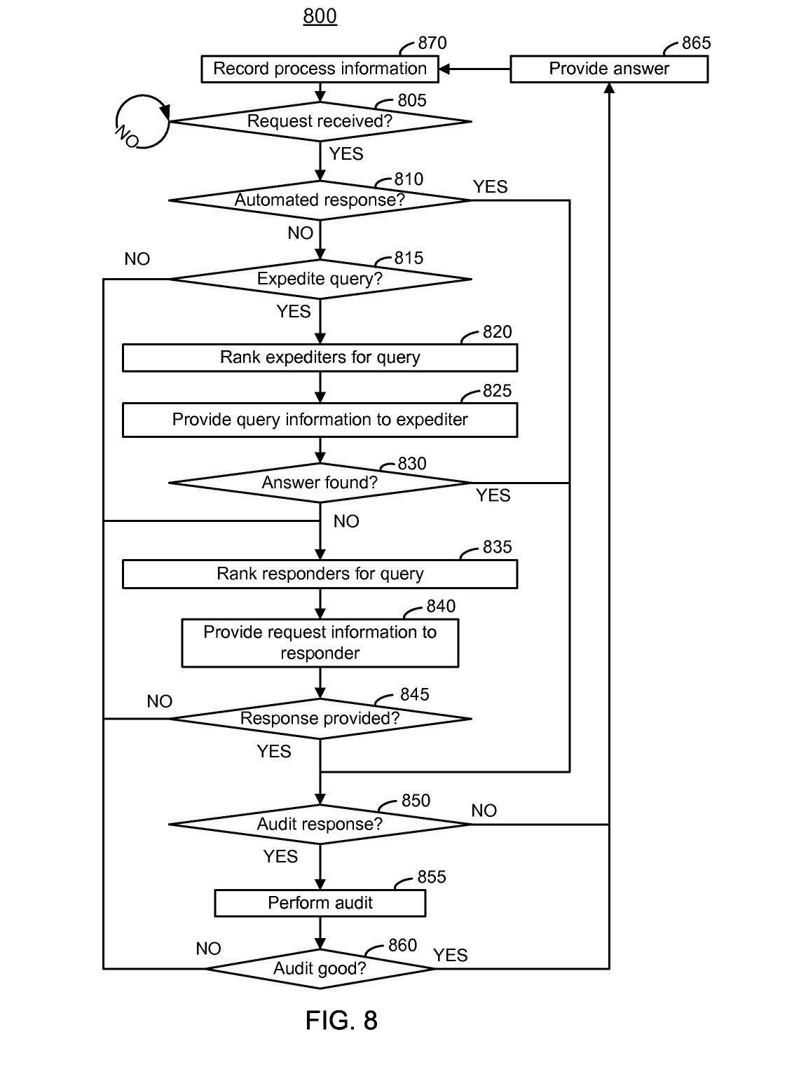

As illustrated in FIG. 7, a process 700 for creating a PEQ is provided. The process 700 may be performed in whole or in part by any suitable element of the system 100 (FIG. 1). In at least one embodiment, the process 700 is operative on a server associated with the search system 130. A request may be a request for an automated answer, a human assisted answer and/or a combination thereof. The process 700 may be incorporated with a process such as the process 800 (FIG. 8).

In operation 705 (FIG. 7) a determination is made as to whether a request is received. If it is determined in operation 705 that a request is not received, control remains at operation 705 and process 700 continues. If it is determined in operation 705 that a request is received, control is passed to operation 710 and process 700 continues.

The determination in operation 705 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. If a message is received at a server associated with the search system 130, it may be determined that a request is received.

In operation 710 a predicted query is determined. For example, user inputs may be obtained and may be processed to determine whether the user inputs can be used to produce a PEQ. A user input may be compared to various databases and may be processed according to rules associated with answer sources. A best matching predicted query may be the predicted query. For example, if a user has provided information which matches a stored query, disambiguation information associated with the user query and the stored query may be determined based on differences between a matching query and an input query. Control is passed to operation 715 and process 700 continues

In operation 715 a predicted query is presented. A predicted query may be presented to a user responsive to user inputs, and may be modified based on further user inputs in a manner similar to predictive queries based on keyword statistics. A PEQ may be presented to a human assistant selected to respond to a request or query. A PEQ may include implicit meanings assigned to elements of a query based on algorithmic predictions. Control is passed to operation 720 and process 700 continues.

In operation 720 a determination is made as to whether a predicted is query accepted. If it is determined in operation 720 that a predicted query is not accepted, control is passed to operation 730 and process 700 continues. If it is determined in operation 720 that a predicted query is accepted, control is passed to operation 725 and process 700 continues.

The determination in operation 720 may be made based on various criteria. If a user request matches a predicted query including parameters required to direct a query to a particular response, it may be determined that the predicted query is accepted. It may be determined that a predicted query is accepted based on an action of a person such as a user or a guide. For example, a GUI may be provided which may be used to indicate acceptance of a query. Any suitable criteria may be used to determine whether a predicted query is accepted.

In operation 725, an accepted query is presented. An accepted query may be presented in combination with a response associated with the query if a stored result is associated with the query. An accepted query may be presented to a user prior to processing of a query if a stored answer is not available. An accepted query may be provided to a human assistant or answerer responding to a request. An accepted query may be presented as audio, video, images, text, etc. Control is passed to operation 730 and process 700 continues.

In operation 730 a determination is made as to whether a required element is provided. If it is determined in operation 730 that a required element is not provided, control is passed to operation 735 and process 700 continues. If it is determined in operation 730 that a required element is provided, control is passed to operation 740 and process 700 continues.

The determination in operation 730 may be made based on various criteria. If a query is matched to a reference query the reference query may be checked to confirm that required elements of the query are provided as described with respect to FIG. 6. A match to a stored query may be used to determine whether a required element is provided. For example, if a query matches a stored query it may be determined that a required element is provided. If a query is a match for more than one stored query it may be determined that a required element is not provided. If a query matches a stored template, pattern, and/or query which is associated with multiple responses it may be determined that a required element is not provided. If an annotation graph is complete it may be determined that a required element is provided. Any number of criteria may be used to determine whether a required element is provided. A human assistant or responder may determine whether a required element is provided. An action of a person such as the user may be used to determine whether a required element is provided. Any suitable criteria may be used to determine whether a required element is provided.

In operation 735, a partial query and is provided. A partial query may include an indication of an element of a query which is required. A partial query may include controls for selecting options for completion of a PEQ. A partial query may include indications of modifications to a query which were performed to select a query and/or PEQ. Providing a partial query may include providing instructions regarding how a PEQ may be determined. Control is passed to operation 740 and process 700 continues.

In operation 740 a query as processed is presented. The query as processed may be presented in conjunction with a response to a request, prior to obtaining a response, or at any suitable time. If a stored or automated response to a query is provided, a PEQ which includes implied elements of the query may be provided. If a plurality of PEQ's matched a query or request a PEQ which has been used to obtain a response may be presented to a user. If multiple PEQ's match a request, a number of those queries and associated responses may be provided. An advertisement associated with the selected PEQ may be provided prior to, with or subsequent to a response. Control is passed to operation 745 and process 700 continues.

In operation 745, process information is recorded. Information of a request, a PEQ, an answer source, a resource, a user, a guide, a responder, an advertisement, a rating, a ranking, etc. may be recorded. A rating or ranking of a reference query answer source, a reference query, a reference query form, a reference query entity source, etc. may be adjusted based on a PEQ and/or response for a request. A list of entities, etc. may be updated based on information of the process. In at least one embodiment, process information is recorded in the database 120 (FIG. 1). Control is passed to operation 705 and process 700 continues.

As illustrated in FIG. 8, a process 800 for responding to a request is provided. The process 800 may be performed in whole or in part by any suitable element of the system 100 (FIG. 1). In at least one embodiment, the process 800 is operative on a server associated with the search system 130.

In operation 805 (FIG. 8) a determination is made as to whether a request is received. If it is determined in operation 805 that a request is not received, control remains at operation 805 and process 800 continues. If it is determined in operation 805 that a request is received, control is passed to operation 810 and process 800 continues.

The determination in operation 805 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. In at least one embodiment, if a message is received at a server associated with the search system 130, it may be determined that a request is received.

In operation 810 (FIG. 8) a determination is made as to whether an automated response is acceptable. If it is determined in operation 810 that an automated response is acceptable, control is passed to operation 850 and process 800 continues. If it is determined in operation 810 that an automated response is not acceptable, control is passed to operation 815 and process 800 continues.

The determination in operation 810 may be made in various ways. For example, a query may be compared to a template, a Regex expression, a historical query, etc. in order to determine whether an automated response is acceptable. An automated response may be any response that is produced by sending a query to a system which retrieves information without intervention by a person. For example, a search engine, an RSS feed, a database look-up of a query, a program resident on a computer system and/or other programmatic system for retrieving information may provide an automated response. In at least one embodiment, an automated response is received based on the process 700 (FIG. 7) if a PEQ is a match to a user request.

In operation 815 a determination is made as to whether a query is to be expedited. If it is determined in operation 815 that a query is to be expedited, control is passed to operation 820 and process 800 continues. If it is determined in operation 815 that a query is not to be expedited, control is passed to operation 835 and process 800 continues.

The determination in operation 815 may be made according to various criteria. An expediter may not be used for all queries originating from a particular source or user. If a query is associated with a predetermined category, is determined to be temporal in nature, is determined to be complex, etc., it may be determined that a query is or is not to be expedited. A number and/or type of available expediters may be used to determine whether a query is to be expedited. For example, if an expediter affiliated with a type of user is not available, a query might be directed to a searcher directly if an affiliated searcher is available. If a request has been determined not to have provided a required element a query may be expedited. Any suitable criteria may be used to determine whether a query is to be expedited.

In operation 820 expediters are ranked for a query. In at least one embodiment, a first available expediter may be a highest ranked expediter. An expediter may be ranked based on a type, category, rating, profile, query, sponsor, etc. Control is passed to operation 825 and process 800 continues.

In operation 825, information of a query is provided to an expediter guide. Any number of expediter guides may be provided with information of a query. An expediter may be provided with a GUI for determining a PEQ. An expediter may be provided with information associated with a stored result, a rendering of a web page associated with the stored result, a rendering of a current web page obtained from a location associated with the stored result, etc. An expediter may be able to communicate with an originator of a request. An expediter may be provided with an indication of corrections and/or modifications to a query as further described herein. Control is passed to operation 830 and process 800 continues.

In operation 830, a determination is made as to whether an answer is found. If in operation 830 it is determined that an answer is found, control is passed to operation 850 and process 800 continues. If in operation 830 it is determined that an answer is not found, control is passed to operation 835 and process 800 continues.

The determination in operation 830 may be made based on various criteria. If an expediter selects a response based on a previous query, confirms a query can be answered programmatically, indicates that a query must be searched, fails to respond, responds in agreement with other expediters, etc. it may be determined that an answer is found. Any suitable criteria may be used to determine whether an answer is found.

In operation 835, responders are ranked for a query. A responder, who may be a guide, may be ranked based on any suitable criteria such as response time, historical activity, percentage and/or number of responses, notifications accepted, responses accepted, categories and/or keywords associated with a responder, temporal information, a profile, etc. Similarly, a person who has responded to and/or accepted a high percentage of notifications or requests may be ranked higher. A quality rating of a responder may be used to rank a responder. A guide may be selected based on a bid of a sponsor. Control is passed to operation 840 and process 800 continues.

In operation 840, information of a request is provided to a responder. For example, a highest ranking responder to respond to a request may be provided with a query, information of resources, information of matching previous requests, information of a user submitting a request, etc. A responder may be presented with PEQ's and/or may be able to create a PEQ based on information of a request. A responder may be able interact with a source of a request and/or other responders. Any number of responders may be provided with information of a request. Control is passed to operation 845 and process 800 continues.

In operation 845, a determination is made as to whether a response is provided. If in operation 845 it is determined that a response is not provided, control is passed to operation 835 and process 800 continues. If in operation 845 it is determined that a response is provided, control is passed to operation 850 and process 800 continues.

The determination in operation 845 may be made based on various criteria. If a responder does not provide a search result within a predetermined period of time, it may be determined that a response is not provided. If a guide indicates completion of a search, it may be determined that a response is provided. If plurality of responders responded to a request, a response by one or more responders may indicate that a response is provided. Any suitable criteria may be used to determine whether a response is provided.

In operation 850, a determination is made as to whether a response is to be audited. If in operation 850 it is determined that a response is not to be audited, control is passed to operation 865 and process 800 continues. If in operation 850 it is determined that a response is to be audited, control is passed to operation 855 and process 800 continues.

The determination in operation 850 may be made based on various criteria. For example, a random sample of automated and/or stored answers might be audited. Sampling might be based on a category of request, a resource or answer source associated with a response, an expediter, a responder and/or searcher, etc. Similarly, a type of user, a commercial relationship, a resource used, etc. might be used to determine whether a response is to be audited. Any suitable criteria may be used to determine whether a response is to be audited.

In operation 855, an audit is performed. An audit may include an automated process. For example, answers provided by answer sources may be compared. An audit may include checking and/or comparison of a stored result to a result obtained from a file returned by a resource associated with a stored answer including a review by a person. An audit may include a searcher performing a search for a query, which may be compared to a stored result. An audit may be performed after an answer has been provided. A response from a responder may be compared to a stored result, automated result, and answer by another responder, etc. An audit may be performed in real-time. Control is passed to operation 860 and process 800 continues

In operation 860, a determination is made as to whether an audit is good. If in operation 860 it is determined that an audit is good, control is passed to operation 865 and process 800 continues. If in operation 860 it is determined that an audit is not good, control is passed to operation 835 and process 800 continues.

The determination in operation 860 may be made based on various criteria. A failure of an automated comparison, a rejection of a stored result by a guide or responder, a mismatch of a searcher result with a stored result, etc. may be used to determine that an audit is not good. Likewise, a person and/or an automated analysis may determine that an audit is good. If a time period for a real-time audit has elapsed, it may be determined that an audit is good. Any suitable criteria may be used to determine whether an audit is good.

In operation 865, an answer is provided. An answer may be delivered to a user via any communication service associated with the user. An answer may include any media which may be delivered using a communication service and a device of the user. For example, an SMS message might be delivered to a user mobile device. Any number of responses may be delivered to a user. A plurality of PEQ's and responses or answers may be provided to a user. Control is passed to operation 870 and process 800 continues

In operation 870, process information is recorded. Information regarding any item such as a user, a guide, a responder, a request, a resource, an advertisement, a user, keyword, category, etc. may be recorded and/or updated. For example, a rating may be adjusted, a keyword, category, type, guide, responder, sponsor, resource, time, user, answer, etc. of a request may be recorded. A rating and/or ranking of a resource may be updated and/or modified. A stored response, a PEQ, a stored query, etc. may be recorded, rated, ranked, or deleted. In at least one embodiment, process information is recorded in the database 120 (FIG. 1). Control is passed to operation 805 and process 800 continues.

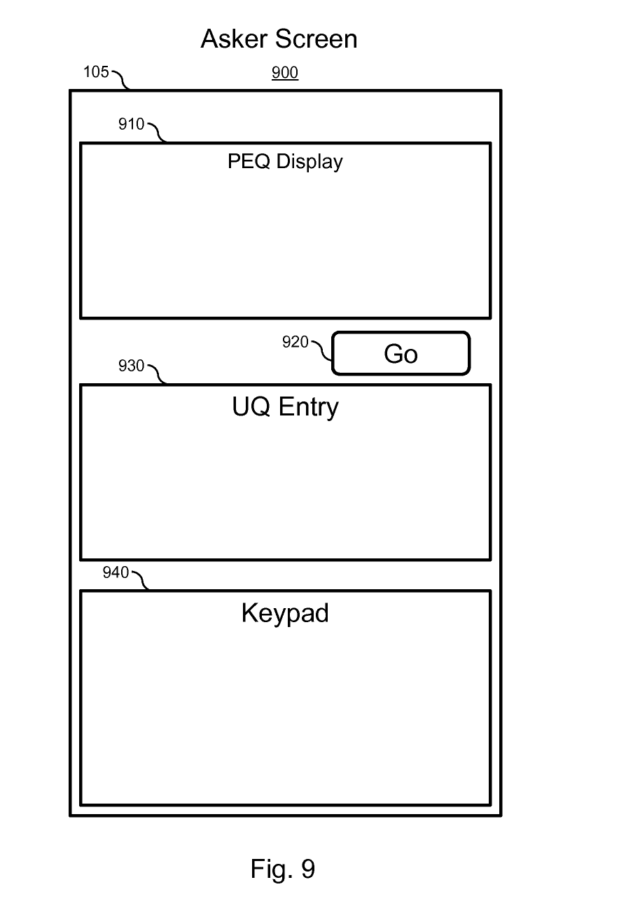

As illustrated in FIG. 9, an exemplary query input GUI 900 is provided. The GUI 900 may be presented using any suitable device associated with the system 100 (FIG. 1) such as the user system 105. The asker screen GUI 900 may include a PEQ display 910, an action control 920, a query entry box 930 and user controls 940. The PEQ display may display any or all of a PEQ which is determined to match a query in the query entry box 930. The PEQ display may display information of modifications to a query in the query entry box 930 which have been applied to match a PEQ. The action control 920 may be used to indicate that a query in the PEQ display 910 is to be submitted for processing. The query entry box 930 may be used to display input for a query. The user controls 940 may be used to provide input for a query. While a keypad is used for illustrative purposes, various types of input may be provided using the user controls such as voice, audio, images, video, text, etc. The GUI 900 may be presented to a user, a guide, a responder, etc.

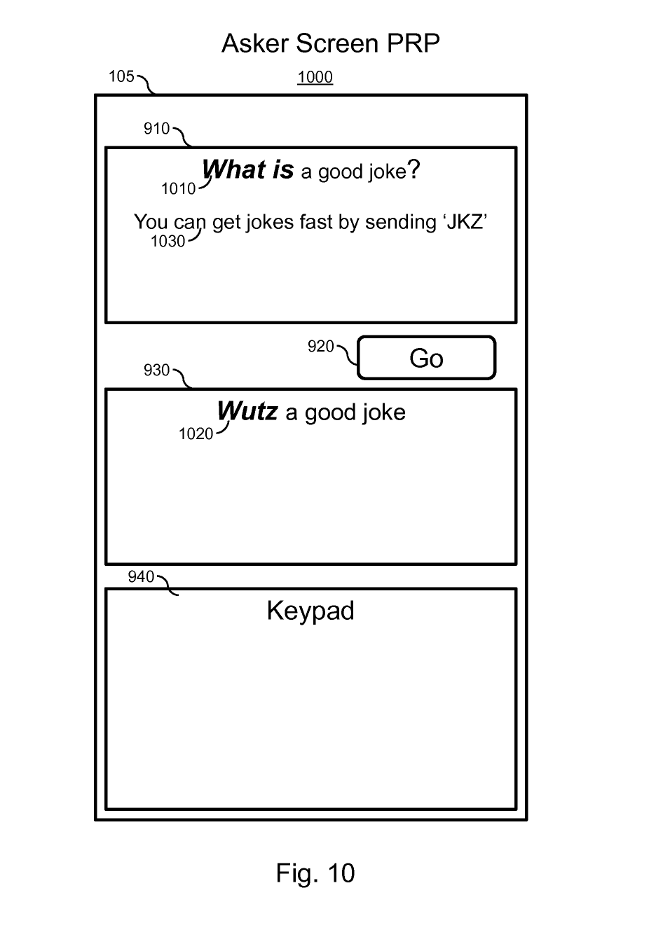

As illustrated in FIG. 10, an exemplary query input GUI 1000 is provided. The GUI 1000 may be presented using any suitable device associated with the system 100 (FIG. 1) such as the user system 105. If a query is a match to a reference query which includes a pattern such as ‘ReferenceQuery1’ as depicted in the reference query record 600a (FIG. 6), a correction to a query in the query entry box 930 may be indicated by a correction indicator 1010 and an error indicator 1020. The error indicator 1020, as indicated by the large font in the query entry box 930 may indicate to a user that an element of a user query may be mapped to a PEQ. The correction indicator 1010 may indicate a correction applied to a query to produce a PEQ as indicated by the large font in the PEQ display 910. An alternate query indicator 1030 may be provided to indicate alternate forms of a PEQ and/or alternate PEQ's which may be applicable to a query indicated in the query entry box 930. Any number of correction indicators, error indicators and alternate query indicators may be provided. Any suitable indication may be used such as color, underlining, etc. A suggested substitution in a query may be indicated in any suitable way. For example, if a plurality of entities may match a user input, a drop-down list or other form of selection interface may be provided as is well known in the art. The GUI 1000 may be presented to a user, a guide, a responder, etc.

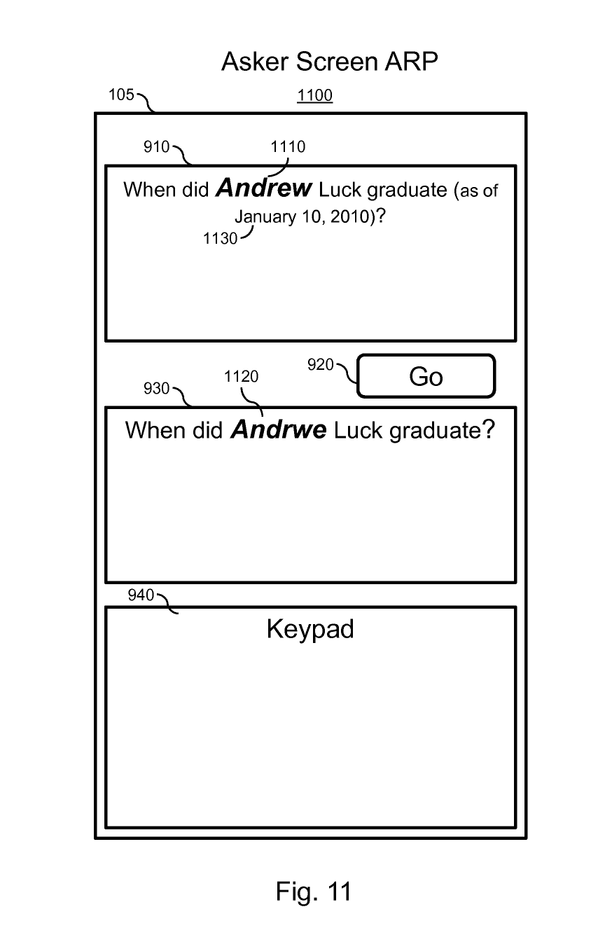

As illustrated in FIG. 11, an exemplary query matching GUI 1100 is provided. The GUI 1100 may be presented using any suitable device associated with the system 100 (FIG. 1) such as the user system 105. If a query is a match to a stored query, auxiliary information such as temporal information may be associated with the stored query. Similarly, an entity in a query may match a stored entity as provided by an answer source. A correction to a query in the query entry box 930 may be indicated by a correction indicator 1110 and an error indicator 1120. The error indicator 1120, as indicated by the large font in the query entry box 930 may indicate to a user that an element of a user query may be mapped to a stored entity. The correction indicator 1110 may indicate a correction applied to a query to match a stored entity as indicated by the large font in the PEQ display 910. An auxiliary information indicator 1130 may be provided to indicate auxiliary information which is associated with a PEQ. For example, if an answer is associated with a stored query which matches a query indicated in the query entry box 930, temporal information associated with the answer may be indicated in the auxiliary information indicator 1130. Similarly if auxiliary information is a required element of a PEQ a default or implied value of auxiliary information associated with a PEQ may be provided in the auxiliary information indicator 1130. Any number of correction indicators, error indicators and auxiliary information indicators may be provided. While temporal information has been used for the purposes of illustration, other elements of a PEQ which are not explicitly provided in a query may be indicated in the PEQ display 910. For example a quantifier, a unit of measure, a relationship, a location, a qualifier, etc. which may be an element of a query may be indicated in an auxiliary information indicator. Any suitable indication may be used such as color, underlining, etc. The auxiliary information indicator 1130 may be suppressed and/or expressed based on various factors. For example if a query element is implied and a probability that the implied information is correct is below a threshold the auxiliary information indicator 1130 may be presented. A categorization associated with a query may affect whether an auxiliary information indicator is provided. For example, if multiple categories are associated with a query, the auxiliary information indicator 1130 might indicate a most probable meaning of a query element based on the most probable category while if only one category is associated with a query the auxiliary information indicator 1130 might be suppressed.

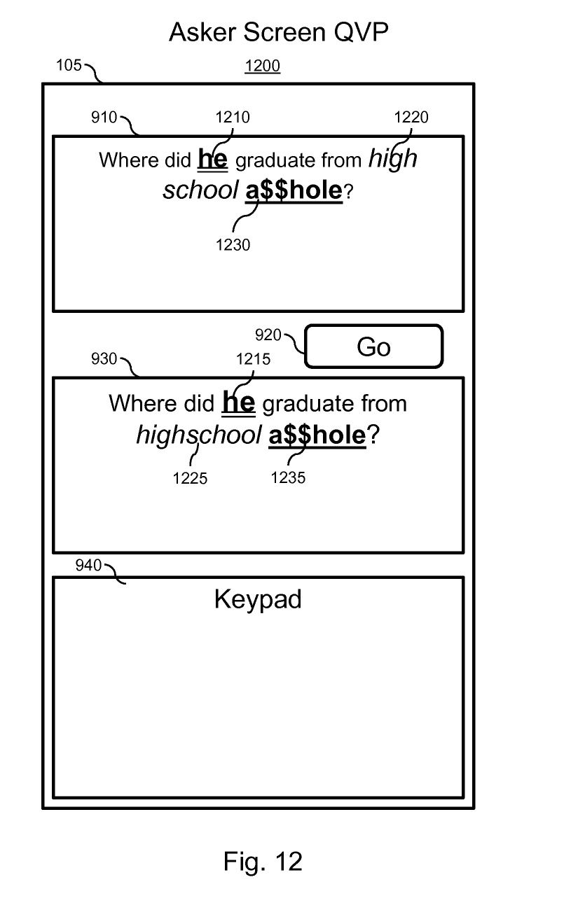

As illustrated in FIG. 12, an exemplary query disambiguation GUI 1200 is provided. The GUI 1200 may be presented using any suitable device associated with the system 100 (FIG. 1) such as the user system 105. In certain instances a query may include elements which cannot be resolved unambiguously be their nature. For example an English pronoun is naturally ambiguous as it can only be resolved based on substitution of a correct noun for the pronoun. In some instances, it is desirable to block certain vocabulary from queries. For example, vulgar terms, offensive language, etc. may be unwanted due to user sensitivities, customer base, or other reasons. As such words which match a lexicon or entity list may be blocked. In such instances a GUI such as the GUI 1200 may be provided. As indicated by the pronoun indicator 1210 and the required element indicator 1215 a PEQ cannot be determined unless an appropriate substitution is performed. A grammar correction indicator 1220 and a grammar error indicator 1225 may be used to indicate an error in a query indicated in the query entry box 930. A blocked vocabulary indicator 1230 and a vocabulary error indicator 1235 may be used to indicate that an element of a query may be prohibited, undesirable, etc. Any suitable indication may be used such as color, underlining, italics, etc. In an embodiment, an element indicated by the pronoun indicator 1210 and/or the blocked content indicator 1230 may block activation of the action control 920 until it is resolved. A user may be provided with a list of noun alternatives if the pronoun indicator 1210 and/or the required element indicator 1215 is activated. Substitutions for a pronoun indicated in the pronoun indicator 1210 may be presented in an order based on ranking of the substitutions. For example, substitutions included in a current query might be highly ranked, substitutions indicated in previous queries might be highly ranked, substitutions associated with a category and/or an entity source associated with a query might be highly ranked. A user may be able to override blocking using the action control 920, activating a respective error indicator, etc. If a query is submitted when an error indicator has not been resolved, or does not meet suitable criteria, the GUI 1300 may be provided to a human assistant who may resolve error indicators.

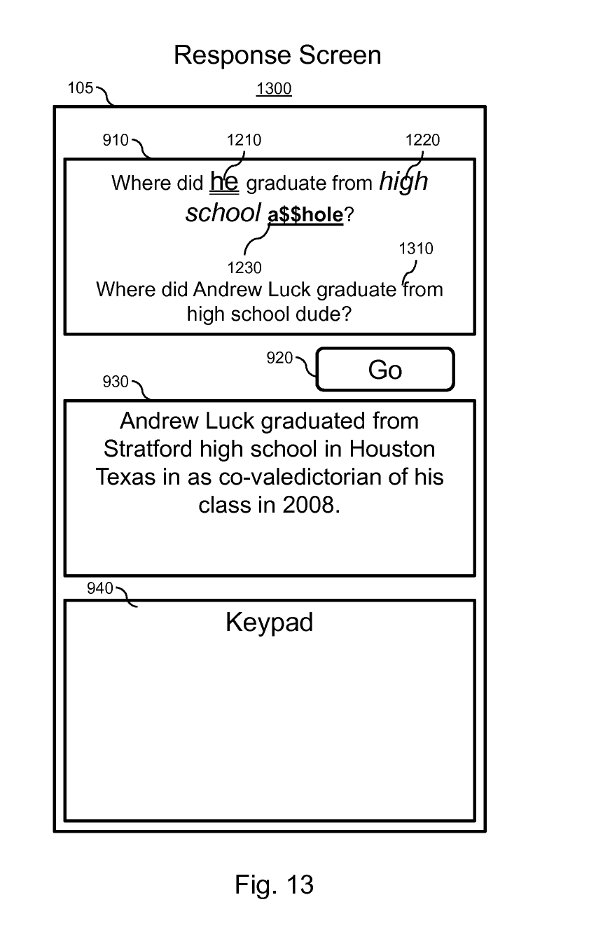

As illustrated in FIG. 13, an exemplary response GUI 1300 is provided. The GUI 1300 may be presented using any suitable device associated with the system 100 (FIG. 1) such as the user system 105. The response GUI may be provided when a user submits a query which may include blocked element, when a user submits a query which does not include required elements, etc. The GUI 1300 may include a processed query indicator 1310. The processed query indicator 1310 may indicate an alternative query and/or PEQ which has been processed to provide a response. The query entry box 930 may indicate a response associated with the processed query indicator 1310. Activation of the processed query indicator 1310 may transfer a query indicated in the processed query indicator 1310 to the query entry indicator 930. The GUI 1300 may include any type of indicators of changes or modifications to a query such as those described in the GUI's 1000, 1100, and 1200.

While specific types of indications such as underlining, bold, etc. and specific user interface elements have been used to describe the GUI's herein, any types of user interface elements and indicators which are well known in the art which may accomplish the functionalities described may be used and the embodiments are not limited to particular implementations of features. Any number of indicators, controls, etc. may be used as required to operate the embodiments.

A method and system for creating and processing a query which may improve processing of a query is described. The system utilizes a combination of automated processing and human inputs to create a query which is to be processed. A query which can be explicitly resolved to a particular result or PEQ is constructed. When a query is submitted query elements which are or may be ambiguous are identified. Corrections and/or supplemental information which may resolve ambiguity in a query is determined, ranked, and may be selectively presented. If a query is resolved to a PEQ, a PEQ associated with a response may be included in a response provided for the query. A human assistant may participate in disambiguation of a query. Query elements which are corrected, modified, etc. may be indicated in a response. Tools which may assist in disambiguation of a query may be presented.

An underlying query structure may be utilized to disambiguate a query. If a query is a match to a template but information required to respond to the query is not found in a database, the query may be accepted and may be presented to a human assistant. A disambiguation vocabulary may be obtained from a resource which may be different from a resource which is used to respond to a request. A PEQ may be created based on a resource from which information may be obtained. A PEQ may be associated with a type of query and/or a source of a query. Information required to select an unambiguous response to a request may be determined implicitly. Implicit information may be presented to a source of a request such as a user prior to initiating a human assisted search. Temporality of a query may be determined based on a PEQ when a stored request associated with an answer is found.

A PEQ may be used to disambiguate a user request. A PEQ may substitute nouns for pronouns and may provide information of a most probable match to a pronoun. A PEQ may be used to restrict vocabulary of a request based on a dictionary.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT), Flash memory. Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method comprising:
receiving a request;
creating a reference query associated with a unique response;
comparing the request to the reference query;
presenting a modification of the request based on the request and the reference query when the request does not match the reference query; and
providing the unique response when the modification is accepted.

2. The method of claim 1 comprising:
indicating a default parameter associated with the reference query when the reference query is a best match to the request.

3. The method of claim 1 comprising:
comparing the request to a database of noun phrases; and
determining the modification based a result of the comparing.

4. The method of claim 3 comprising:
assigning a noun phrase of the database to a portion of the request; and
indicating a substitution of the noun phrase for the portion of the request as the modification.

5. The method of claim 1 comprising:
creating the reference query based on a relationship between a noun phrase and a data structure of a database.

6. The method of claim 1 comprising:
creating an annotation graph of the request comprising a token and a semantic identifier of the token;
ranking reference queries comprising the reference query based on the annotation graph;
presenting the modification based on a highest ranking reference query; and
providing the unique response and the reference query when the modification is not accepted.

7. The method of claim 1 comprising:
identifying a pronoun in the request; and
recommending a noun to replace the pronoun based on a profile of a source of the request.

8. The method of claim 1 comprising:
including location information in the modification when the request is location sensitive and presenting the location information when a probability associated with the location is below a predetermined threshold.

9. The method of claim 1 comprising:
including a substitute for a word of the request in the modification when the substitute is associated with an index of human assistants.

10. The method of claim 1 comprising:
including a substitute for a word of the request in the modification when the substitute is associated with an index of human assistants and a match of the reference query to the request is below a predetermined threshold.

11. The method of claim 1 comprising:
including a selection control in the modification when a confidence function of a modification of a portion of the request is below a predetermined threshold.

12. The method of claim 1 comprising:
directing the request to a human assistant when a source of the request rejects the modification.

13. The method of claim 12 comprising:
revising content of the database based on a query created by the human assistant.

14. A system comprising:
a user device submitting a request; and
a search system device receiving the request, creating a reference query associated with a unique response comparing the request to the reference query, presenting a modification of the request based on the request and the reference query when the request does not match the reference query, and providing the unique response when the modification is accepted.

15. The system of claim 14 further comprising:
a responder device receiving the request and the reference query when the modification is not accepted.

16. A non-transient computer readable storage medium storing therein an instruction for causing a computer to execute an operation, comprising:
receiving a request;
creating a reference query associated with a unique answer;
comparing the request to the reference query;
presenting a modification of the request based on the request and the reference query when the request does not match the reference query; and
providing the unique answer when the modification is accepted.

17. The computer readable storage medium of claim 16 wherein the operation further comprises:
identifying a pronoun of the request; and
substituting a named entity of a previous request of a source of the request for the pronoun.

18. The computer readable storage medium of claim 16 wherein the operation further comprises:
ranking reference queries based on the request; and
presenting a differential between the highest ranking reference query and the request as the modification.

19. The computer readable storage medium of claim 16 wherein the operation further comprises:
presenting the request and the reference query to a human assistant; and
providing information of the reference query to a source of the request when the human assistant accepts the reference query.

20. The computer readable storage medium of claim 16 wherein the operation further comprises:
creating the reference query based on a noun of the request and a data structure; and
presenting the reference query to a human searcher when the unique answer is not available.
